(19) United States
(12) Patent Application Publication
(10) Pub. No.: US 2006/0202844 A1
(43) Pub. Date: Sep. 14, 2006

(54) Structure failure alert system

(75) Inventor: Daniel G. Farley, Westminster, MA (US)

Correspondence Address: Dean D. Small;Armstrong Teasdale LLP, Ste. 2600, One Metropolitan Square, St. Louis, MO, 63102, US

(73) Assignee: SimplexGrinnell LP

(21) Appl. No.: 11/340,047

(22) Filed: Jan. 26, 2006

Related U.S. Application Data
(60) Provisional application No. 60/660,104, filed on Mar. 8, 2005.

(51) Int. Cl. G08B 17/12

(52) U.S. Cl. 340/577

(57) ABSTRACT

A structural failure alert system includes a structure failure sensor configured to be placed, substantially permanently, within an interior of a building, the sensor positioned and configured to monitor a condition of the infrastructure of the building and generate a structure integrity signal based thereon, and a failure analysis package configured to be loaded into a control module communicating with the sensor, the failure analysis package receiving and analyzing the structure integrity signals from the sensors, the failure analysis package producing a structural failure indication when a potential structural failure exists.

### CROSS REFERENCE TO RELATED APPLICATIONS

This application claims priority to U.S. Provisional Application Ser. No. 60/660,104, filed Mar. 8, 2005, which is hereby incorporated by reference in its entirety.

### BACKGROUND OF THE INVENTION

This invention relates generally to firefighting systems and more particularly to a method and apparatus to facilitate detecting a structural collapse.

Advancements in personal protective equipment (PPE) have enabled firefighters to operate and survive in relatively extreme conditions when fighting fires within a building. However, the personal protective equipment may not provide a firefighter with adequate protection when the firefighter is exposed to a structural failure within the building. For example, a structural failure may cause the firefighter to become trapped within a building and/or sealed off from a known exit path.

To determine if a building is becoming unstable, firefighters generally utilize various human observations. For example, firefighters may rely on physical observations of the building such as observing bowed walls or feeling for softness in a floor area. However, physical observations may be unreliable and are often limited by the physical signs that are visible to the firefighters. As a result, firefighters may lack knowledge of a potential structural failure which may result in the firefighter being injured, or to run out of air after becoming entangled or disoriented as an indirect result of a structural collapse.

### BRIEF DESCRIPTION OF THE INVENTION

In one aspect, a structural failure alert system is provided that includes a structure failure sensor configured to be placed, substantially permanently, within an interior of a building. The sensor is positioned and configured to monitor a condition of the infrastructure of the building and generate a structure integrity signal based thereon. The system also includes a failure analysis package that is configured to be loaded into a control module that communicates with the sensor. During operation, the failure analysis package receives and analyzes the structure integrity signals received from the sensors and produces a structural failure indication when a potential structural failure exists.

In another aspect, a method for predicting a structural failure in a building includes placing a structure failure sensor substantially permanently within an interior of the building, the sensor positioned and configured to monitor a condition of the infrastructure of the building and generate a structure integrity signal based thereon, and loading a failure analysis package into a control module communicating with the sensor. The failure analysis package receiving and analyzing the structure integrity signals from the sensors and producing a structural failure indication when a potential structural failure exists.

In a further aspect, a failure analysis package configured to be loaded into a control module receives an input from a structure failure sensor configured to be placed, substantially permanently, within an interior of a building. The sensor is positioned and configured to monitor a condition of the infrastructure of the building and to generate a structure integrity signal based thereon when a potential structural failure exists.

### BRIEF DESCRIPTION OF THE DRAWINGS

FIG. 1 is a schematic illustration of a building including an exemplary structural failure alert system;

FIG. 2 is a schematic illustration of the structural failure alert system shown in FIG. 1;

FIG. 3 is a method of operating the structural failure alert system shown in FIGS. 1 and 2; and

FIG. 4 is an optional structural failure alert system.

### DETAILED DESCRIPTION OF THE INVENTION

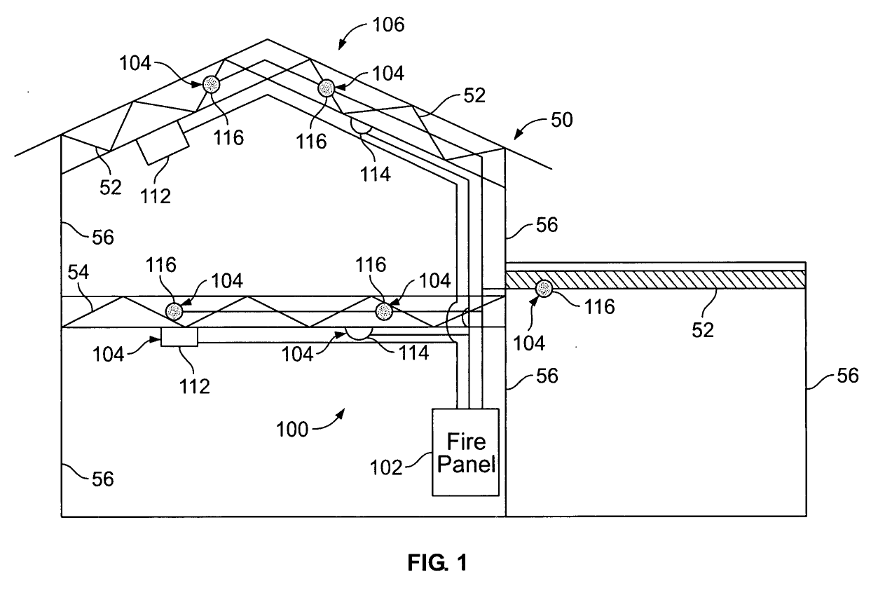

FIG. 1 is a schematic diagram of a building 50 that includes an exemplary structural failure alert system 100 in accordance with an embodiment of the present invention. Building 50 may include a plurality of roof trusses 52, a plurality of floor trusses 54, and a plurality of walls 56 extending the between the roof and floor trusses 52 and 54, respectively. Optionally, building 50 may be constructed utilizing a plurality of wooden or metallic beams without limiting the scope of the invention described herein. In one embodiment, the roof and floor trusses 52 and 54 are fabricated from a fibrous material such as wood, for example. Optionally, the roof and floor trusses 52 and 54 are fabricated from a metallic material. As such, the roof and floor trusses 52 and 54 may experience structural failure under differing load conditions or when exposed to different temperatures.

As a result, the structural failure alert system 100 is utilized to provide a structural failure indication when a potential structural failure exists within building 50. Although the structural failure alert system 100 described herein receives signals from sensors that are coupled to roof trusses 52, floor trusses 54, and/or walls 56, it should be realized that the structural failure alert system 100 may also receive signals from a plurality of sensors that are each coupled at various locations within building 50 that may be subject to a potential structural failure.

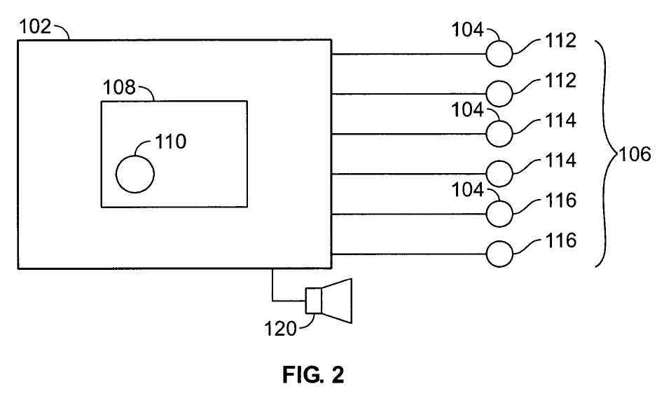

FIG. 2 is a schematic illustration of the structural failure alert system 100. Structural failure alert system 100 includes at least one fire detection panel 102, also referred to as a fire control panel, and at least one structure failure sensor 104 that is coupled to fire detection panel 102. In the exemplary embodiment, structural failure alert system 100 includes a plurality of structure failure sensors 104 that form a sensor group 106 that is placed substantially permanently within an interior of building 50 and configured to monitor a condition of building 50 and generate a structure integrity signal based thereon. The term, “substantially permanently” is used throughout to represent mounting techniques and structures that retain a device, sensor, or the like, for a period of time determined by the normal life of the device, sensor, and the like. For example, a sensor having a typical 3-10 year useful life may remain within the building for 3-10 years. The period of time the sensor remains within the building is independent of, and longer than, the duration of an emergency that could give rise to a structural failure. A sensor brought into a building by a firefighter during a fire condition, and then removed from the building after the fire condition is over, is not a permanent sensor. Permanent structure failure sensors 104 are coupled at various locations within building 50. For example, structure failure sensors 104 may be coupled to any of the roof trusses 52, floor trusses 54, and/or walls 56. More specifically, the structure failure sensors 104 are positioned at various predetermined locations within the structure 50 wherein a structural failure is most likely to occur. For example, in the exemplary embodiment, the structure failure sensors are coupled to adjacent roof trusses 52 and floor trusses 54 to facilitate determining a structural failure. Although building 50 is shown as having two separate levels, it should be realized that the structure failure alert system 100 described herein may be utilized in a building having a single level or more than two levels, for example a single family home, or optionally, a high rise building.

In one embodiment, structure failure sensors 104 are wired in series to fire detection panel 102. Optionally, structure failure sensors 104 are wired in parallel to fire detection panel 102. Fire detection panel 102 is placed substantially permanently, within building 50 and remains with the building over the life of the building, and includes a control module 108 that is coupled within the fire detection panel 102. The control module 108 includes a structural failure analysis package 110 that will be discussed below. Structure failure sensors 104 may detect emissions of at least one of the products associated with fire including combustion gas, smoke, flame, and/or heat. In the exemplary embodiment, structure failure sensors 104 include for example, but are not limited to, temperature sensors 112, e.g. thermo couplers, smoke sensors 114, and a plurality of separation sensors 116 that are each spaced about an area to be monitored for fire and possible structural collapse. In the exemplary embodiment, separation sensor 116 may constitute an electrical device that is coupled between adjacent trusses or walls and configured to generate a signal when movement occurs between the adjacent trusses or wall. Separation sensor 116 may also be an accelerometer that is coupled to a single truss or wall and configured to generate a signal when the single wall or truss moves. The separation sensor 116 may also constitute an optical device that senses the movement of at least one of the roof trusses 52, floor trusses 54, and/or walls 56 and transmits a signal to the fire detection panel 102 when movement has occurred. Optionally, the separation sensor 116 may constitute a mercury switch that detects when building 50 has moved or tilted.

Structure failure sensors 104 are each coupled to fire detection panel 102 such that signals transmitted from structure failure sensors 104 are received by control module 108. In one embodiment, structure failure sensors 104 may be hard-wired to fire detection panel 102. Optionally, structure failure sensors 104 may transmit a signal, such as a radio frequency (RF), an infrared signal (IR), or an optical signal, for example, that is transmitted to and received by fire detection panel 102. Moreover, the structure failure sensors 104 may be utilized as a heat sensor to indicate that a fire condition has initially occurred, and also as a structural sensor to indicate structure failure. As such, each structure failure sensor may be operable to sense or detect smoke, fire, and/or structural conditions and to transmit a signal to the structural failure analysis package 110 or to an analysis/decision making module utilized with system 100.

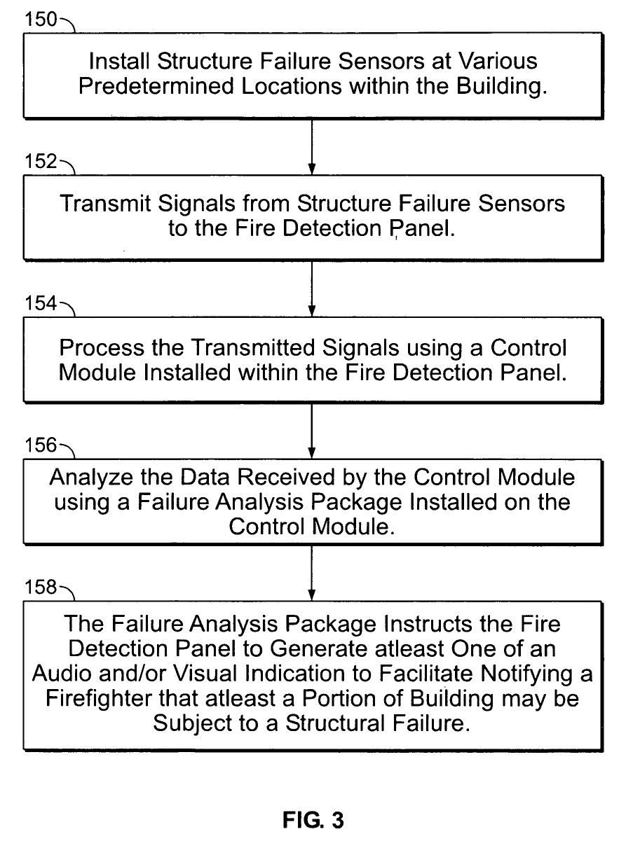

During operation, and as shown in FIG. 3, structure failures sensors are installed 150 within building 50 at various desired locations where a structural collapse may occur. The signals relative to a concentration and/or presence of the products associated with fire are approximately continuously transmitted 152 from each structure failure sensor 104 to fire detection panel 102 wherein the signals are processed 154 using control module 108. The analog or digital signal is continuously transmitted from each structure failure sensor 104 and received approximately simultaneously by control module 108. Optionally, control module 108 is configured to process 154 each structure failure sensor continuously at a predetermined rate that is based on the processor speed of control module 108.

The signals generated by temperature sensors 112, smoke sensors 114, and/or separation sensors 116 are each transmitted to control module 108 wherein the signals are analyzed 156 to determine an actual or potential structural failure using failure analysis package 110. In the exemplary embodiment, control module 108 may be represented as a computer and failure analysis package 110 may be represented as a program that is stored on and/or executed by the control module 108 to determine either an actual or potential structural failure based on the signals received from at least one of temperature sensor 112, smoke sensor 114, and separation sensors 116.

The failure analysis package 110 then analyzes the data transmitted by structure failure sensors 104 and based on predetermined criteria installed in the control module 108 either determines that an actual structural failure has occurred or optionally predicts that a structural failure may occur within building 50. In the exemplary embodiment, the predetermined criteria may be represented as a priori knowledge of building 50 that includes the various locations in which the sensors 104 are installed and the known temperatures at which the steel trusses, wooden trusses and/or walls begin to rapidly lose their strength resulting in the walls and/or trusses either warping and/or failing. Specifically, the steel and wood trusses begin to fail at known temperatures.

As such, the failure analysis package 110 is continuously monitoring the data received from the structure failure sensors 104 and comparing the received data to the a priori knowledge to predict a structural failure within building 50 or optionally to determine that a structural failure has already occurred. Specifically, the signals transmitted from each temperature sensor 112 are each received by control module 108. Control module 108 then compares the received signals to the predetermined criteria, e.g. the a priori knowledge, to determine if any of the received signals meets or exceeds the predetermined criteria. If at least one of the received signals meets or exceeds the predetermined criteria, that is, the temperature within the building 50 is approaching a value in which at least a portion of the structure will begin to lose strength, the control module 108 will generate a signal indicating the location of the potential structural failure. The failure analysis package instructs 158 the fire detection panel 102 to generate at least one of an audio and/or visual indication to facilitate notifying a firefighter that at least a portion of building 50 may be subject to a structural failure. In operation, the fire detection panel 102 transmits a signal to a communication device 120, that emits one of an audio or visual indication of a predicted and/or actual structural failure. Optionally, the fire detection panel 102 activates a device such as, but not limited to, a strobe light or an audio device.

Additionally, the separation sensors 116 are utilized to detect actual building components that are beginning to separate from each other. For example, the failure analysis package 110 is continuously monitoring the data received from the separation sensors 116 and comparing the received data to the a priori knowledge to predict a structural failure within building 50 or optionally to determine that a structural failure has already occurred. Specifically, the signals transmitted from each separation sensors 116 are each received by control module 108. Control module 108 then compares the received signals to the predetermined criteria, e.g. the a priori knowledge, to determine if any of the received signals meets or exceeds the predetermined criteria. If at least one of the received signals meets or exceeds the predetermined criteria, that is, at least one separation sensor indicates movement of a wall or truss that is sufficient to cause a structural failure, the control module 108, or optionally that a structural failure has occurred, the failure analysis package 110 instructs the fire detection panel 102 to notify the firefighting personnel that at least a portion of building 50 may be unstable and in danger of structural failure or collapse. In operation, the fire detection panel 102 transmits a signal to a communication device 120, that emits one of an audio or visual indication of a predicted and/or actual structural failure.

In the exemplary embodiment, communication device 120 may be represented as a speaker that emits an audio signal that is different than audio an audio signal that may be generated by the standard fire alarm. Optionally, communication device 120 may be represented as a visual indicator, e.g. flashing lights, that are positioned at various locations within building 50, a visual indication that is observable at the fire detection panel 102, and/or a signal may be transmitted directly to a communication device carried by the firefighter. The fire detection panel 102 may transmit a signal to remote locations outside building 50 to facilitate notifying firefighters that a structural failure has or may occur within the building and thus provide firefighters notice of a pending structural failure prior to the firefighters entering the building 50.

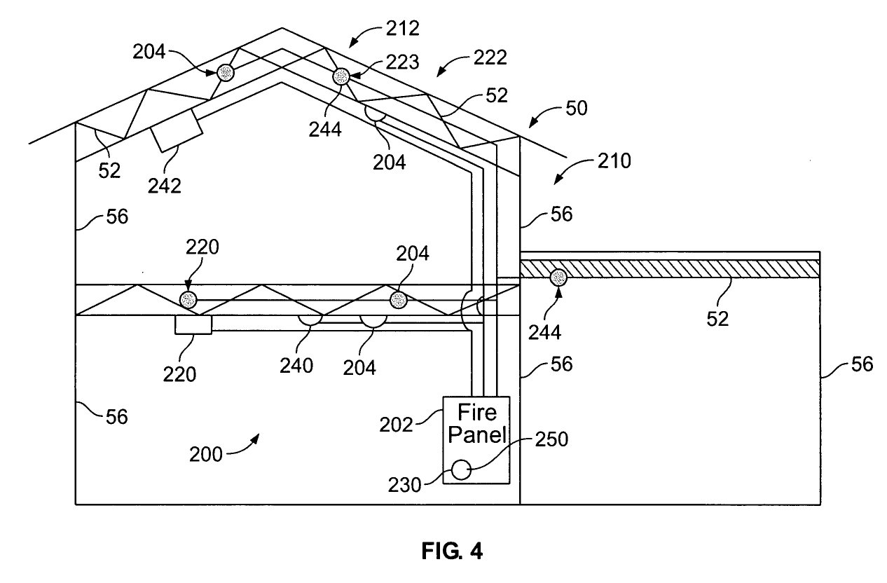

FIG. 4 illustrates a building 50 that includes an existing firefighting system 200 that includes a known fire detection panel 202, a plurality of known sensors 204 coupled to fire detection panel 202, and a structural failure alert system 210 that may be utilized to upgrade or repair firefighting system 200. Structural failure alert system 210 includes a sensing means 212 that may be represented by at least one structure failure sensor 220 that is coupled to fire detection panel 202. In the exemplary embodiment, the sensing means 212 includes a plurality of structure failure sensors 220 that form a sensor group 222 that is placed substantially permanently within an interior of building 50 and configured to monitor a condition of building 50 and generate a structure integrity signal based thereon. As used herein, substantially permanently is defined as a sensor that is installed within building 50 and remains with building 50 during the normal life of building 50.

In the exemplary embodiment, the sensing means 212 are coupled at various locations within building 50. For example, the sensing means 212 may be coupled to any of the roof trusses 52, floor trusses 54, and/or walls 56 within building 50. The structure failure sensors 220 are installed by a technician at various predetermined locations within the structure 50 wherein a structural failure is most likely to occur.

In one embodiment, structure failure sensors 220 are wired in series to fire detection panel 202. Optionally, structure failure sensors 220 are wired in parallel to fire detection panel 202. Fire detection panel 202 includes an existing control module 230 that is coupled within the fire detection panel 202 that includes an existing software package. Structure failure sensors 220 may detect emissions of at least one of the products associated with fire including combustion gas, smoke, flame, and/or heat. In the exemplary embodiment, structure failure sensors 220 include for example, but are not limited to, temperature sensors 240, e.g. thermo couplers, smoke sensors 242, and at least one separation sensor 244 that are each spaced about an area to be monitored for fire and possible structural collapse. In the exemplary embodiment, separation sensor 244 may constitute an electrical device that is coupled between adjacent trusses or walls and configured to generate a signal when movement occurs between the adjacent trusses or wall. Separation sensor 244 may also be an accelerometer that is coupled to a single truss or wall and configured to generate a signal when the single wall or truss moves. Optionally, the separation sensor 244 may constitute an optical device that senses the movement of at least one of the roof trusses 52, floor trusses 54, and/or walls 56 and transmits a signal to the fire detection panel 202 when movement has occurred.

To repair or upgrade fire detection system 200, a technician may install the structure failure sensors 220 and couple the structure failure sensors 220 to the fire detection panel 202 such that signals transmitted from structure failure sensors 220 are received by a control module 230 installed within fire detection panel 202. In one embodiment, structure failure sensors 220 may be hard-wired to fire detection panel 204. Optionally, structure failure sensors 220 may transmit a signal, such as a radio frequency (RF), an infrared signal (IR), or an optical signal, for example, that is transmitted to and received by fire detection panel 202. To repair fire detection system 200 a technician may replace non-functional structure failure sensors 220 with functioning sensors 220. Optionally, to upgrade system 200, a technician may install at least one structure failure sensor 220 and couple the structure failure sensor 220 to the fire detection panel 202 such that signal transmitted from the structure failure sensor 220 is received by the control module 230. Additionally, the technician may replace the software program installed within control module 230 with a processing means 232. In the exemplary embodiment, the processing means 232 may be represented by a failure analysis package 250 that is programmed to analyze signals transmitted from the existing sensors and also analyze signals received from the structure failure sensors 220.

Specifically, the technician may utilize a laptop computer that includes the failure analysis package 250 to install the package into the fire detection system. In one embodiment, the failure analysis package substantially overwrites the existing software package. Optionally, the failure analysis package modifies the existing software to recognize the structure failure sensors and to further analyze the data transmitted by the existing sensors and the structure failure sensors 220 and based on predetermined criteria programmed within failure analysis package 250 either determines that an actual structural failure has occurred or optionally predicts that a structural failure may occur within building 50. In the exemplary embodiment, the predetermined criteria may be represented as a priori knowledge of building 50 that includes the various locations in which the existing sensors are installed and the locations in which the newly installed structure failure sensors are installed. The failure analysis package includes the known temperatures at which the steel trusses, wooden trusses and/or walls begin to rapidly lose their strength resulting in the walls and/or trusses either warping and/or failing. Specifically, the steel and wood trusses begin to fail at known temperatures.

As such, the failure analysis package 250 is continuously monitoring the data received from the existing sensors and the structure failure sensors 220 and comparing the received data to the a priori knowledge to predict a structural failure within building 50 or optionally to determine that a structural failure has already occurred.

The above-described embodiments of a fire detection system and upgrade each provide a cost-effective and reliable means for determining a structural collapse within a building. Specifically, a failure analysis package is loaded into a fire detection panel permanently installed within the building. The failure analysis package receives inputs from various sensors permanently installed within the building and based on the information received from the sensors, the failure analysis package instructs the fire detection panel to transmit and audio or visual indication to the firefighters that a structural failure has or may occur.

In one embodiment, a structural failure alert system incorporates at least one sensor that is responsive to structural movement. Optionally, the structural failure alert system may incorporate a group of sensors which, in addition to the at least one sensor, may include one or more fire detection sensors from a group including heat or temperature sensors including thermistors, smoke sensors based on optical obscuration, smoke sensors based on optical scattering, smoke sensors based on mobility changes in ionized air, optical flame detectors responding to radiant emissions from flames, electrochemical carbon monoxide sensors, and other sensors.

The structural failure alert system incorporates a control and evaluation device or system which is connected to the sensor group, set up to evaluate the one or more signals supplied by the sensor group, and if necessary, set up to output at least one control signal. The at least one control signal may be used to activate an alarm or notification process. The at least one control signal may be also used to modify the operation or signals of devices within the sensor group.

As used herein, an element or step recited in the singular and proceeded with the word “a” or “an” should be understood as not excluding plural elements or steps, unless such exclusion is explicitly recited. Furthermore, references to “one embodiment” of the present invention are not intended to be interpreted as excluding the existence of additional embodiments that also incorporate the recited features. The term computer is not limited to just those integrated circuits referred to in the art as computers, but broadly refers to, microprocessors, microcontrollers, microcomputers, programmable logic controllers, application specific integrated circuits, and other programmable circuits, and these terms are used interchangeably herein.

Exemplary embodiments of fire detection systems and apparatus are described above in detail. The fire detection system components illustrated are not limited to the specific embodiments described herein, but rather, components of each system may be utilized independently and separately from other components described herein. For example, the fire detection system components described above may also be used in combination with different fire detection system components.

While the invention has been described in terms of various specific embodiments, those skilled in the art will recognize that the invention can be practiced with modification within the spirit and scope of the claims.

What is claimed is:

1. A structural failure alert system, comprising:
a structure failure sensor configured to be placed, substantially permanently, within an interior of a building, the sensor positioned and configured to monitor a condition of an infrastructure of the building and generate a structure integrity signal based thereon; and
a failure analysis package configured to be loaded into a control module communicating with the sensor, the failure analysis package receiving and analyzing the structure integrity signals from the sensors, the failure analysis package producing a structural failure indication when a potential structural failure exists.

2. The system of claim 1, wherein the failure analysis package stores predetermined failure criteria, the failure analysis package producing the structural failure indication when the structure integrity signal satisfies the predetermined failure criteria.

3. The system of claim 1, wherein the failure analysis package is loaded into a control module of a fire detection panel, the fire detection panel communicating with the sensors and receiving fire detection signals from the sensors indicating that a potential fire exists within the building.

4. The system of claim 1, wherein the failure analysis package is loaded into a control module of an existing fire detection panel permanently mounted in the building.

5. The system of claim 1, wherein the sensor monitors at least one of structural movement and temperature.

6. The system of claim 1, wherein the sensor constitutes one of an accelerometer, thermo coupler, and moment detector.

7. The system of claim 1, further comprising an output unit communicating with the failure analysis package, the output unit generating one of an audio indication and a visual indication of a potential structural failure exists.

8. A method for predicting a structural failure in a building comprising:
placing a structure failure sensor substantially permanently within an interior of a building, the sensor positioned and configured to monitor a condition of the infrastructure of the building and generate a structure integrity signal based thereon; and
loading a failure analysis package into a control module communicating with the sensor, the failure analysis package receiving and analyzing the structure integrity signals from the sensors, the failure analysis package producing a structural failure indication when a potential structural failure exists.

9. The method of claim 8 further comprising:
storing predetermined failure criteria in the failure analysis package; and
producing the structural failure indication when the structure integrity signal satisfies the predetermined failure criteria.

10. The method of claim 8 further comprising loading the failure analysis package into a control module of a fire detection panel, the fire detection panel communicating with the sensors; and
receiving fire detection signals from the sensors indicating that a potential fire exists within the building.

11. The method of claim 8 further comprising loading the failure analysis package into a control module of an existing fire detection panel permanently mounted in the building.

12. The method of claim 8 further comprising utilizing the sensor to monitor at least one of structural movement and temperature.

13. The method of claim 8 wherein the sensor constitutes one of an accelerometer, thermo coupler, and moment detector, said method further comprising placing one of the accelerometer, thermo coupler, and moment detector permanently within an interior of a building,

14. The method of claim 8 further comprising generating one of an audio indication and a visual indication of a predicted structural failure.

15. A failure analysis package configured to be loaded into a control module, said software package configured to:
receive an input from a structure failure sensor configured to be placed, substantially permanently, within an interior of a building, the sensor positioned and configured to monitor a condition of the infrastructure of the building; and
generate a structure integrity signal based thereon when a potential structural failure exists.

16. The failure analysis package of claim 15, wherein the failure analysis package is further configured to:
store predetermined failure criteria; and
produce the structural failure indication when the structure integrity signal satisfies the predetermined failure criteria.

17. The failure analysis package of claim 15, wherein the failure analysis package is loaded into a control module of a fire detection panel, said failure analysis package configured to receive fire detection signals from fire detection sensors indicating that a potential fire exists within the building.

18. The failure analysis package of claim 15, wherein the failure analysis package is loaded into a control module of an existing fire detection panel permanently mounted in the building, said failure analysis package configured to receive fire detection signals from fire detection sensors indicating that a potential fire exists within the building.

19. The failure analysis package of claim 15, wherein the failure analysis package is configured monitor at least one of structural movement and temperature, and generate an indication that a potential structural failure exists within the building based on the structural movement and temperature.

20. The failure analysis package of claim 15, wherein the sensor constitutes one of an accelerometer, thermo coupler, and moment detector, said failure analysis package configured to receive a signal from the accelerometer, thermo coupler, and generate an indication that a potential structural failure exists within the building based on either the accelerometer, thermo coupler, or moment detector.

21. The failure analysis package of claim 15, further configured to an output unit, the output unit generating one of an audio indication and a visual indication of a predicted structural failure.

22. A structural failure alert system, comprising:
a sensing means configured to be placed, substantially permanently, within an interior of a building, the sensing means positioned and configured to monitor a condition of an infrastructure of the building and generate a structure integrity signal based thereon; and
a processing means configured to be loaded into a control module communicating with the sensing means, the processing means receiving and analyzing the structure integrity signals from the sensing means, the processing means producing a structural failure indication when a potential structural failure exists.

23. The system of claim 22, wherein the processing means stores predetermined failure criteria, the processing means producing the structural failure indication when the structure integrity signal satisfies the predetermined failure criteria.

24. The system of claim 22, wherein the processing means is loaded into a control module of a fire detection panel, the fire detection panel communicating with the sensing means and receives fire detection signals from sensing means indicating that a potential fire exists within the building.

25. The system of claim 22, wherein the processing means is loaded into a control module of an existing fire detection panel permanently mounted in the building.

26. The system of claim 22, wherein the sensor monitors at least one of structural movement and temperature.

27. The system of claim 22, wherein the sensing means constitutes one of an accelerometer, thermo coupler, and moment detector.

28. The system of claim 22, wherein the processing means constitutes a structural failure analysis package programmed to analyze the structure integrity signals from the sensing means and produce a structural failure indication when a potential structural failure.

29. A method of modifying an existing fire detection system installed in a building, the fire detection system includes a fire detection panel, a control module, at least one sensor coupled to the fire detection panel, and a software package installed in the control module, said method comprising:
installing a failure analysis package into the control module such that the failure analysis package substantially overwrites the software package, the failure analysis package receiving and analyzing the signals from the sensors, the failure analysis package producing a structural failure indication when a potential structural failure exists.

30. The method of claim 29 further comprising:
placing a structure failure sensor substantially permanently within an interior of a building, the structure failure sensor positioned and configured to monitor a condition of the infrastructure of the building, the failure analysis package receiving and analyzing the structure integrity signals from the structure failure sensors, the failure analysis package producing a structural failure indication when a potential structural failure exists.
